(19) United States
(12) Patent Application Publication
(10) Pub. No.: US 2005/0088409 A1
(43) Pub. Date: Apr. 28, 2005

(54) Method of providing a display for a gui

(76) Inventor: Cees Van Berkel, Hove (GB)

Correspondence Address: PHILIPS INTELLECTUAL PROPERTY & STANDARDS, P.O. BOX 3001, BRIARCLIFF MANOR, NY, 10510, US

(21) Appl. No.: 10/505,495

(22) PCT Filed: Feb. 3, 2003
(86) PCT No.: PCT/IB03/00381

(30) Foreign Application Priority Data
Feb. 28, 2002 (GB) 0204652.2

(51) Int. Cl. G09G 5/08

(52) U.S. Cl. 345/157

(57) ABSTRACT

A method of providing a display for a GUI comprising the step of displaying a pointer (13) on the display (11) in a position corresponding to the position of a user's hand in a plane of a sensing region of a touchless input device (12) is disclosed together with a computer program, a computer-readable storage medium and apparatus for the same. In particular, the method further comprises the step of displaying an indication (15) on the display of the distance between the user's hand and either a reference point located in or adjacent the sensing region or a reference plane, parallel with the first plane and located through or adjacent the sensing region; or, alternatively, displaying an indication on the display of a suitable gesture of the user's hand for the purpose of manipulating the pointer.

This invention relates to a method of providing a display for a graphical user interface (GUI) and to a computer program, a computer-readable storage medium and apparatus for the same. In particular, the invention relates to providing a display for a GUI in which a pointer is displayed on the display in a position corresponding to the position of a user's hand in a plane of a sensing region of a touchless input device.

Touchless input devices are well known. For example, U.S. patent application 2002/0000977 A1 discloses a three-dimensional interactive display system comprising a transparent “capaciflector” camera formed on a transparent shield layer on a screen surface which is able to detect an object such as a probe or finger intruding in the vicinity of that screen surface. In particular, FIGS. 11A and 11B, which are flow diagrams showing the steps to effect a basic cursor movement while in a word processing program, and corresponding paragraphs 0057 to 0059 of the description disclose that lateral movement of the probe or finger causes a cursive, i.e. a pointer, to follow the probe in real time, highlighting words, pictures and equations it traverses. The presence of the cursive, corresponding to the presence of a probe or finger, is indicated by the cursive being displayed blinking, initially energetically.

U.S. Pat. No. 6,025,726 discloses an alternative to capacitive sensing in which electric field sensing is used to provide a touchless sensing region.

According to the present invention, a method of providing a display for a GUI of the aforementioned type is provided, further comprising the step of displaying an indication on the display of the distance between the user's hand and either a reference point located in or adjacent the sensing region or a reference plane, parallel with the first plane and located through or adjacent the sensing region; and/or displaying an indication on the display of a suitable gesture of the users hand for the purpose of manipulating the pointer.

In the case of the former, the method may further comprising the step of removing the indication in response to the user's hand exceeding a predetermined distance from the reference, perhaps corresponding to a boundary of the sensing region beyond which the touchless input device is unable to detect movement of the users hand and so manipulate the pointer. Also, the indication may be a graphic having a size proportional to the distance between the user's hand and the reference.

In either case, the indication may be a graphic positioned around or adjacent the pointer and optionally move with the pointer.

The inventor has realised that the sensitivity to which a touchless input device can track the position of the user's hand will vary depending on the distance of the user's hand from the most sensitive part of the sensing region and also the gesture, i.e. the shape of the hand, adopted by the user. The inventor has also realised that if a user adopts an unsuitable gesture such as pointing to the screen, the user may expect the pointer to be at the end of the user's finger whereas because of the practical limitations of sensing technology such as difficulties in resolving ambiguities concerning orientation, size and gesture of the user's hand, this may not be the case and this may be perceived by the user to be inaccuracy. By providing an indication on the display of the distance between the user's hand to a reference located in or adjacent the sensing region, as opposed to mere presence as in U.S. patent application 2002/0000977 A1, the user is provided with an indication of the sensitivity for any given hand position. Similarly, by providing an indication on the display of a suitable gesture of the user's hand for the purpose of manipulating the pointer, the user is less likely to adopt an unsuitable gesture.

The present invention will now be described, by way of example only, with reference to the accompanying figures in which:

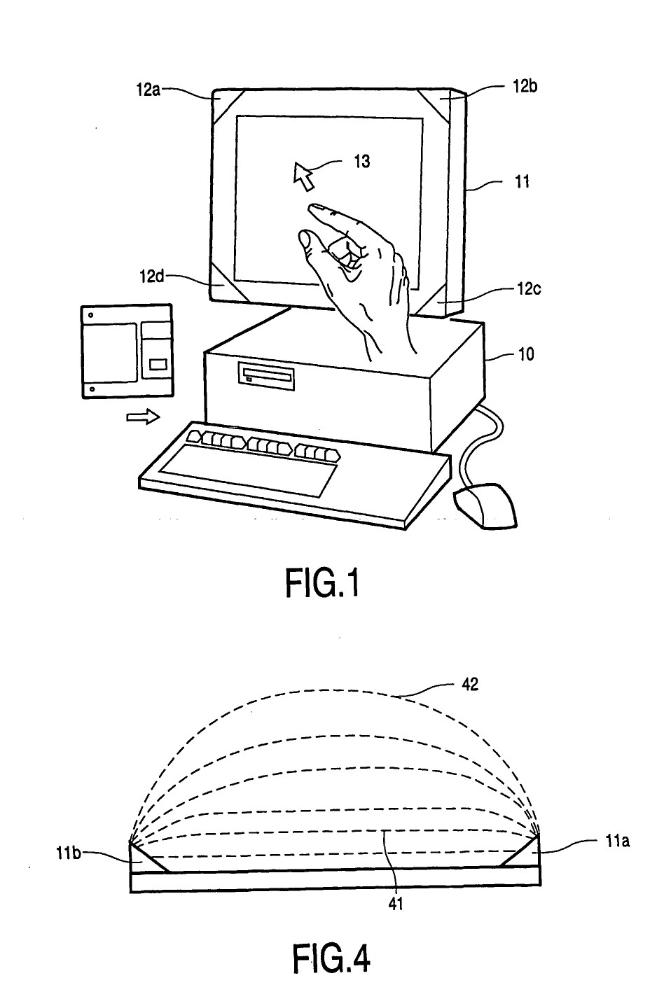

FIG. 1 is a perspective view of a computer configured to generate, in accordance with the present invention, a screen display for the conventional flat panel display having an integral touchless input device and to which the computer is connected;

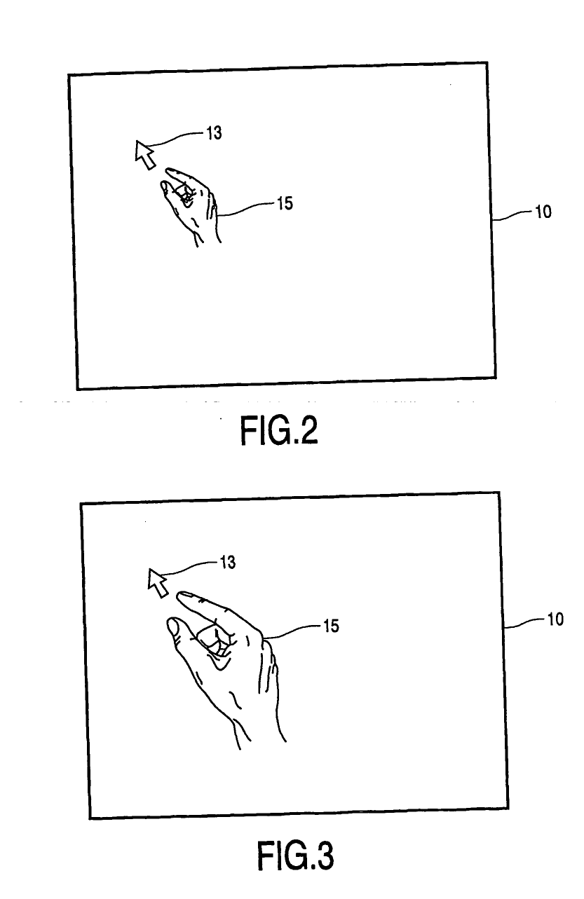

FIGS. 2 and 3 show screen displays generated by the computer of FIG. 1; and

FIG. 4 is a section through the flat panel display having an integral touchless device illustrating, and shows example lines of detection sensitivity for a touchless input device mounted on a display.

FIG. 1 is a perspective view of a computer 10 configured to generate, in accordance with the present invention, a screen display for the conventional flat panel display 11 with integral touchless input device 12 to which it is connected. The touchless input device comprises four sensors 12a, 12b, 12c, 12d, one located at each of the four corners of the display panel, and provides a sensing region in front of the display. A user may manipulate a pointer 13 displayed on the display by movement of the hand in a plane through the sensing region, parallel to the display. The pointer is shown as an arrowhead but of course any other graphic suitable for indicating a point on the display could be used.

The accuracy to which the touchless input device can measure the position of the user's hand will vary depending on the distance of the users hand from the optimum part of the sensing region and also the gesture, i.e. the shape of the hand, adopted by the user.

In accordance with the present invention and with reference to FIG. 2, an image of a hand 15 is displayed adjacent the pointer 13 to remind the user of the optimum gesture of the user's hand for the purpose of manipulating the pointer. This encourages the user to hold their hand in a particular way, so enhancing the accuracy to which the touchless input device can measure the position of the user's hand. The image of the hand 15 moves with the pointer so as to continually aid the user in manipulating the pointer.

Further in accordance with the present invention and as illustrated in FIG. 3, the size of the image of the hand changes proportionally to the distance between the user's hand and the display.

As the user's hand moves further from the display, the image of the hand is enlarged, as shown in FIG. 3, so as to indicate to the user the increasing imprecise relationship between hand position and pointer position. This encourages the user to keep their hand closer to the screen when accurate, and therefore predictable, interaction with the pointer is required. Conversely, when fast and less accurate interaction is required, the user may find it appropriate to hold their hand further from the screen.

As an alternative to the image of the hand, any other suitable graphic may be used and also, such an image or graphic need not move with the pointer. For example, a simple circle of varying size located in a corner of the display may provide an indication of the distance of the user's hand from the display.

As an alternative to the image of the hand varying in size in response to a user's hand moving further from the display, the image may alternatively fade in intensity with increasing hand-display separation and possibly to the extent that it disappears completely at a critical distance. Also, the touchless input device need not be integral with the display but can be located remote from the display, for example, on a horizontal surface adjacent the computer, perhaps giving the user the sensation of controlling a virtual mouse.

A user may select a point on the display by locating the pointer on that point and keeping their hand still for a predetermined period of time or alternatively, by making a quick swiping movement across the display.

FIG. 4 shows a schematic view of the top edge of the display 11.

Example lines of detection sensitivity are shown between two of the sensors 12a and 12b. Such lines may exist if electric field sensing technology is employed to measure the position of a user's hand in the sensing region. Even in this simplified 2-D representation of the field, it can be seen that the lines 41 close to the display are substantially straight (planar when considered in 3-D) and of uniform separation. This region provides more accurate position sensing than that further from the display. At greater distances the lines 42 are less straight and are of irregular spacing. This gives a less accurate determination of a user's hand position. From this, it can be seen that it is preferable for a user to hold their hand closer to the display when required to manipulate the pointer accurately.

Implementation of a method according to the present invention in such a computer system may be readily accomplished in hardware, in software (either in situ on a computer or stored on storage media) by appropriate computer programming and configuration or through a combination of both. Of course, such programming and configuration is well known and would be accomplished by one of ordinary skill in the art without undue burden. It would be further understood by one of ordinary skill in the art that the teaching of the present invention applies equally to other types of apparatus having a touchless input device and not only to the aforementioned computer system.

1. A method of providing a display for a GUI comprising the steps of:
displaying a pointer on the display in a position corresponding to the position of a user's hand in a plane of a sensing region of a touchless input device; and
displaying an indication on the display of the distance between the user's hand and either a reference point located in or adjacent the sensing region or a reference plane, parallel with the first plane and located through or adjacent the sensing region.

2. A method according to claim 1 further comprising the step of removing the indication in response to the user's hand exceeding a predetermined distance from the reference.

3. A method according to claim 1 or claim 2 wherein the indication is a graphic of a size proportional to the distance between the user's hand and the reference.

4. A method of providing a display for a GUI comprising the steps of:
displaying a pointer on the display in a position corresponding to the position of a user's hand in a plane of a sensing region of a touchless input device; and
displaying an indication on the display of a suitable gesture of the user's hand for the purpose of manipulating the pointer.

5. A method according to any previous claim wherein the display is integral with the touchless input device

6. A method according to any preceding claim wherein the indication is a graphic positioned around or adjacent the pointer.

7. A method according to claim 6 wherein the graphic moves with the pointer.

8. A method according to any preceding claim further comprising the step of selecting a point on the display when the user's hand remains still for a predetermined period of time.

9. A computer program comprising instructions for performing a method according to any preceding claim.

10. A computer-readable storage medium having recorded thereon data representing instructions for performing a method according to any of claims 1 to 8.

11. Apparatus having a display, a touchless input device and a processor configured to perform a method according to any of claims 1 to 8.
